(19) United States
(12) Patent Application Publication
(10) Pub. No.: US 2018/0373016 A1
(43) Pub. Date: Dec. 27, 2018

(54) MICROSCOPE HAVING A REFRACTIVE INDEX MATCHING MATERIAL

(71) Applicant: SCOPIO LABS LTD., Tel Aviv (IL)

(72) Inventors: Ben LESHEM, III, Tel Aviv (IL); Eran SMALL, Tel Aviv (IL); Ittay MADAR, Tel Aviv (IL); Erez NAAMAN, Tel Aviv (IL); Itai HAYUT, Tel Aviv (IL)

(21) Appl. No.: 15/774,855

(22) PCT Filed: Nov. 10, 2016
(86) PCT No.: PCT/IB2016/001715

§ 371 Date: May 9, 2018

Related U.S. Application Data
(60) Provisional application No. 62/253,732, filed on Nov. 11, 2015.

(51) Int. Cl. G02B 21/36; G02B 21/06; G02B 27/58; G06T 3/40

(52) U.S. Cl. CPC G02B 21/367; G06T 3/4053; G02B 27/58; G02B 21/06

(57) ABSTRACT

A microscope includes an illumination assembly configured to illuminate a sample under two or more different illumination conditions, at least one image capture device configured to capture image information associated with the sample at each of the two or more different illumination conditions, at least one processing device programmed to generate an image of the sample based on a combination of image information captured at each of the two or more different illumination conditions, and at least one refractive index matching material between the illumination assembly and the sample. The refractive index matching material is different from a medium between the at least one image capture device and the sample.

### CROSS REFERENCE TO RELATED APPLICATION

This application claims the benefit of priority of U.S. Provisional Patent Application No. 62/253,732, filed on Nov. 11, 2015, which is incorporated herein by reference in its entirety.

### BACKGROUND

### I. Technical Field

The present disclosure relates generally to microscopy and, more specifically, to microscopes that include a refractive index matching material.

### II. Background Information

Today's commercial microscopes rely on expensive and delicate optical lenses and typically need additional hardware to share and process acquired images. Moreover, for scanning optical microscopy, additional expensive equipment such as accurate mechanics and scientific cameras are required. A new generation of microscope technology, known as computational microscopy, has begun to emerge, and makes use of advanced image-processing algorithms (usually with hardware modifications) to overcome limitations of conventional microscopes. A computational microscope can, in some cases, produce high-resolution digital images of samples without using expensive optical lenses. In addition, a computational microscope may open the door for additional capabilities based on computer vision, sharing of data and enhanced imaging capabilities.

In many microscopy applications, it is desirable to illuminate the sample, sometimes placed on top or embedded within a glass slide, at a high incidence angle. This can be challenging due to effects related to the transition between air and the sample slide, which have different refractive indices. For example, even in cases where light is generated at a high initial incidence angle, the light actually impinging on the sample may have a significantly reduced incidence angle due to refraction. That is, the incident light beam traveling in air with an incident angle of a (in relation to a line perpendicular to the glass slide) will enter the glass with a smaller incident angle which equals arcsin(sin α/n), where n is the refractive index, i.e., 1.5 for glass. The smaller incident angle may limit the resolution of the images generated by the microscope, especially for computational microscopes. Using an index-matching material can allow the numerical aperture of the illumination to be larger than 1, whereas without it, in a transition between air and glass, it is limited to a maximal value of 1. Therefore, it is desirable to reduce the effect of refraction in order to improve image quality. In computational microscopy there are resolution enhancement methods that can benefit greatly from illumination angles larger than the acceptance angle (related to numerical aperture) of the objective lens, and so solutions for enabling effectively illuminating the sample with large angles are highly valuable. Additionally, there are many practical engineering benefits from using specific materials between the illumination and the sample, different than the materials between the sample and the imaging system. These benefits can be related, for example, to the need for physical movement between the imaging system and the sample. Therefore, solutions that practically enable high illumination angles are desirable.

### SUMMARY

Disclosed systems relate to the field of computational microscopes. Certain disclosed embodiments are directed to microscopes including refractive index matching materials between a sample and an illumination assembly. Certain disclosed embodiments may also include microscopes having refractive index matching materials between the sample and an objective lens.

Consistent with a disclosed embodiment, a microscope is provided. The microscope may include an illumination assembly configured to illuminate a sample under two or more different illumination conditions, at least one image capture device configured to capture image information associated with the sample at each of the two or more different illumination conditions, at least one processing device programmed to generate an image of the sample based on a combination of image information captured at each of the two or more different illumination conditions, and at least one refractive index matching material between the illumination assembly and the sample. The refractive index matching material may be different from a medium between the at least one image capture device and the sample.

In another disclosed embodiment, a microscope is provided. The microscope may include an illumination assembly configured to illuminate a sample under two or more different illumination conditions, at least one image capture device configured to capture image information associated with the sample at each of the two or more different illumination conditions, at least one processing device programmed to generate a high resolution image of the sample based on a combination of image information captured at each of the two or more different illumination conditions. The high resolution image of the sample may have a resolution higher than any individual one of the plurality of images. The microscope may further include at least one refractive index matching material between the illumination assembly and the sample. The refractive index matching material may different from a medium between the at least one image capture device and the sample.

Consistent with yet another disclosed embodiment, a microscope is provided. The microscope may include an illumination assembly configured to illuminate a sample under two or more different illumination conditions, at least one image capture device configured to capture image information associated with the sample at each of the two or more different illumination conditions, at least one processing device programmed to generate an image of the sample based on a combination of image information captured at each of the two or more different illumination conditions, a first refractive index matching material between the illumination assembly and the sample, and a second refractive index matching material between the at least one image capture device and the sample. The first refractive index matching material may include a first gel, and the second refractive index matching material may include a second gel.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary microscope including a refractive index matching material formed as a solid cube, consistent with a disclosed embodiment.

FIG. 2A is a diagrammatic representation of an exemplary microscope including a refractive index matching material, consistent with a disclosed embodiment.

FIG. 2B is a diagrammatic representation of an exemplary microscope including a refractive index matching material formed as a solid hemisphere, consistent with another disclosed embodiment.

FIG. 3 is a diagrammatic representation of an exemplary microscope including a first refractive index matching material between a sample and an illumination assembly, and a second refractive index matching material between the sample and an image capture device, consistent with a disclosed embodiment.

FIG. 4 is a diagrammatic representation of an exemplary microscope including a refractive index matching material having first and second portions, consistent with a disclosed embodiment.

FIG. 5 is a diagrammatic representation of an exemplary microscope including a refractive index matching material having first and second portions, consistent with another disclosed embodiment.

FIG. 6 is a diagrammatic representation of an exemplary microscope including a refractive index matching material that contacts a sample, consistent with a disclosed embodiment.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The disclosed embodiments may include microscopes that use one or more cameras to provide high resolution images of a sample. For example, the microscope may include an illumination assembly configured to illuminate a sample under two or more different illumination conditions, at least one image capture device configured to capture image information associated with the sample at each of the two or more different illumination conditions, at least one processing device programmed to generate an image of the sample based on a combination of image information captured at each of the two or more different illumination conditions, and at least one refractive index matching material between the illumination assembly and the sample. The refractive index matching material may be different from a medium between the at least one image capture device and the sample.

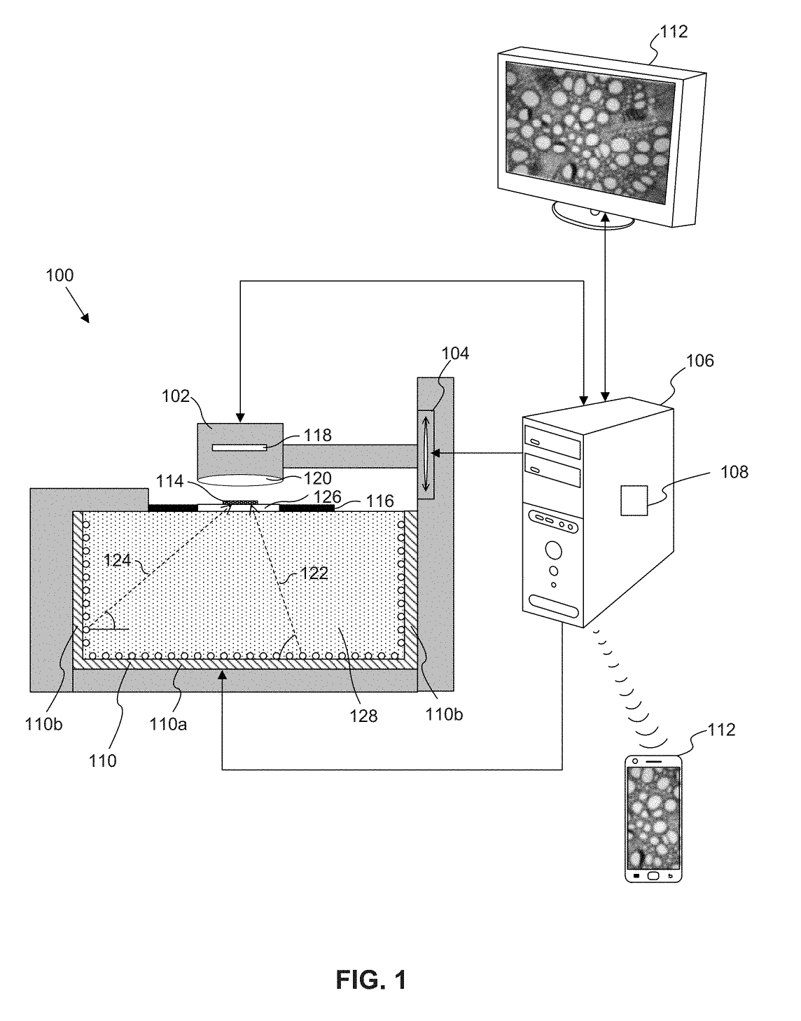

FIG. 1 is a diagrammatic representation of a microscope 100 including a refractive index matching material, consistent with an exemplary embodiment. The term “microscope” refers to any device or instrument for magnifying an object which is smaller than easily observable by the naked eye, i.e., creating an image of an object for a user where the image is larger than the object. One type of microscope may be an “optical microscope” that uses light in combination with an optical system for magnifying an object. An optical microscope may be a simple microscope having one or more magnifying lens. Another type of microscope may be a “computational microscope” that includes an image sensor and image-processing algorithms to enhance or to magnify the object or portions of the object. The computational microscope may be a dedicated device or created by incorporating software and/or hardware with an existing optical microscope to produce high-resolution digital images.

As shown in FIG. 1, microscope 100 includes an image capture device 102, a focusing actuator 104, a controller 106 that may be connected to memory 108, an illumination assembly 110, and a user interface 112. An example usage of microscope 100 may be capturing images of a sample 114 mounted on a stage 116 located within the field-of-view (FOV) of image capture device 102, processing the captured images, and presenting on user interface 112 a magnified image of sample 114. In some embodiments, sample 114 may be blood cells, chromosomes, tissue biopsy, sperm cells, etc.

Image capture device 102 may be used to capture images of sample 114. In this specification, the term “image capture device” includes a device that records the optical signals entering a lens as an image or a sequence of images. The optical signals may be in the near-infrared, infrared, visible, and ultraviolet spectrums. Examples of an image capture device include a CCD camera, a photo sensor array, a video camera, a mobile phone equipped with a camera, etc. Some embodiments may include only a single image capture device 102, while other embodiments may include two, three, or even four or more image capture devices 102. In some embodiments, image capture device 102 may be configured to capture images in a defined field-of-view (FOV). Also, when microscope 100 includes several image capture devices 102, image capture devices 102 may have overlap areas in their respective FOVs. Image capture device 102 may use one or more image sensors for capturing image data of sample 114. In other embodiments, image capture device 102 may be configured to capture images at an image resolution higher than 10 Megapixels, higher than 12 Megapixels, higher than 15 Megapixels, or higher than 20 Megapixels. In addition, image capture device 102 may also be configured to have a pixel size smaller than 5 micrometers, smaller than 3 micrometers, or smaller than 1.6 micrometer. A region between image capture device 102 and sample 114 may include air.

In the embodiment illustrated in FIG. 1, image capture device 102 includes an image sensor 118 and an objective lens 120. The term “image sensor” refers to a device capable of detecting and converting optical signals into electrical signals. The electrical signals may be used to form an image or a video stream based on the detected signals. Examples of image sensor 118 may include semiconductor charge-coupled devices (CCD), active pixel sensors in complementary metal-oxide-semiconductor (CMOS), or N-type metal-oxide-semiconductor (NMOS, Live MOS). The term “lens” may refer to a ground or molded piece of glass, plastic, or other transparent material with opposite surfaces either or both of which are curved, by means of which light rays are refracted so that they converge or diverge to form an image. The term “lens” also refers to an element containing one or more lenses as defined above, such as in a microscope objective. The term ‘lens’ may also include a scattering or diffracting optical element that is configured to transfer light in a specific way for the purpose of imaging. The lens is positioned at least generally transversely of the optical axis of image sensor 118. Objective lens 120 may be located in a region (e.g., top region in the embodiment illustrated in FIG. 1) opposing sample 114 and illumination assembly 110. Objective lens 120 may be used for collecting light transmitted through sample 114 and directing the collected light towards image sensor 118. In some embodiments, image capture device 102 may include a fixed lens or a zoom lens. As illustrated in FIG. 1, a region between objective lens 120 and sample 114 includes air.

In some embodiments, microscope 100 includes focusing actuator 104. The term “focusing actuator” refers to any device capable of converting input signals into physical motion for adjusting the relative distance between sample 114 and image capture device 102. Various focusing actuators may be used, including, for example linear motors, electrostrictive actuators, electrostatic motors, capacitive motors, voice coil actuators, magnetostrictive actuators, etc. In some embodiments, focusing actuator 104 may include an analog position feedback sensor and/or a digital position feedback element. Focusing actuator 104 is configured to receive instructions from controller 106 in order to control the distance between sample 114 and image capture device 102 or some of its components. However, in other embodiments, focusing actuator 104 may be configured to adjust the distance by moving stage 116, or by moving both image capture device 102 and stage 116.

Microscope 100 may also include controller 106 for controlling the operation of microscope 100 according to the disclosed embodiments. Controller 106 may comprise various types of processing devices for performing logic operations on one or more inputs of image data and other data according to stored or accessible software instructions providing desired functionality. For example, controller 106 may include a central processing unit (CPU), support circuits, digital signal processors, integrated circuits, cache memory, or any other types of devices for image processing and analysis such as graphic processing units (GPUs). The CPU may comprise any number of microcontrollers or microprocessors configured to process the imagery from the image sensors. For example the CPU may include any type of single or multi-core processor, mobile device microcontroller, etc. Various processors may be used, including, for example, processors available from manufacturers such as Intel®, AMD®, etc. and may include various architectures (e.g., x86 processor, ARM®, etc.). The support circuits may be any number of circuits generally well known in the art, including cache, power supply, clock and input-output circuits.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106. Specifically, memory 108 may refer to multiple structures or computer-readable storage mediums located at controller 106 or at a remote location, such as, a cloud server. Memory 108 may comprise any number of random access memories, read only memories, flash memories, disk drives, optical storage, tape storage, removable storage and other types of storage.

Microscope 100 may include illumination assembly 110. The term “illumination assembly” refers to any device or system capable of projecting light to illuminate sample 114. Illumination assembly 110 may include one or more light sources such as, for example, light emitting diodes (LEDs), LED arrays, a laser, halogen lamps, or a mercury lamp Illumination assembly 110 may include more than one kind of light source configured to emit light. Illumination assembly 110 may include any number of light sources, such as light emitting diodes (LEDs), configured to emit light. In one embodiment, illumination assembly 110 may include only a single light source. Alternatively, illumination assembly 110 may include four, sixteen, or even more than a hundred light sources organized in an array or a matrix. In some embodiments, the illumination assembly may also include a device to manipulate light (for example a spatial light modulator or a rotatable polarizer). The one or more light sources may be disposed at fixed locations in the illumination assembly or may be configured as one or more movable light sources.

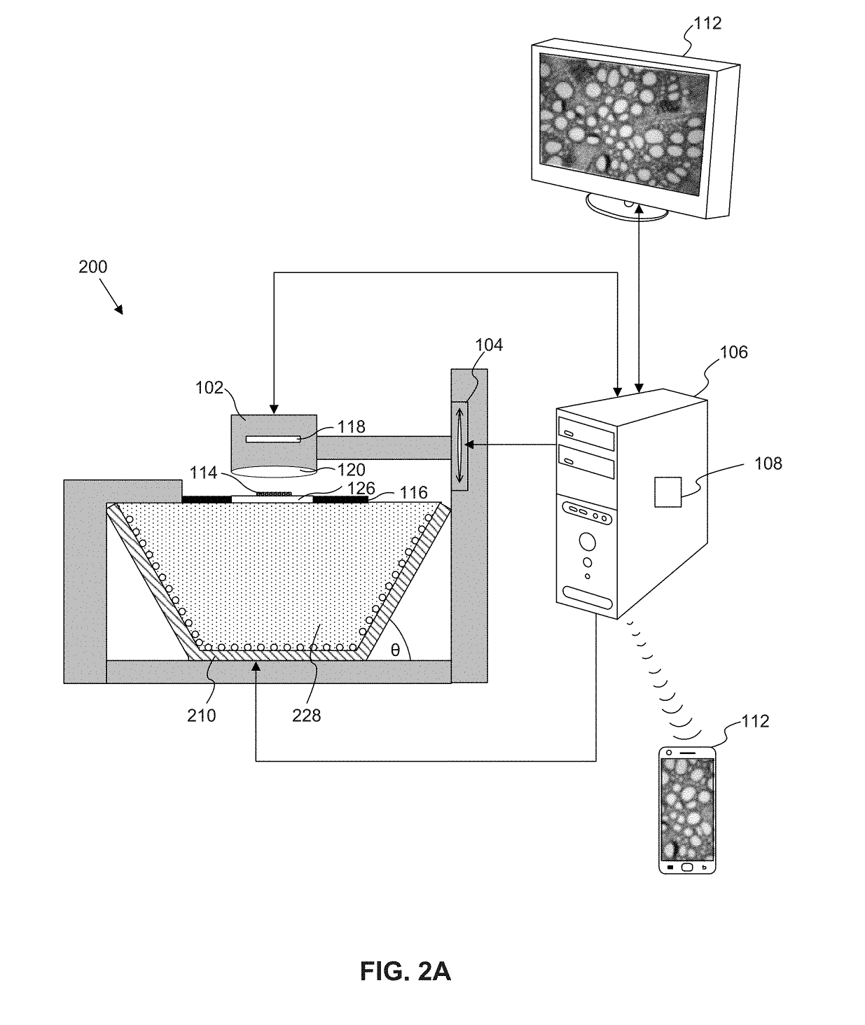

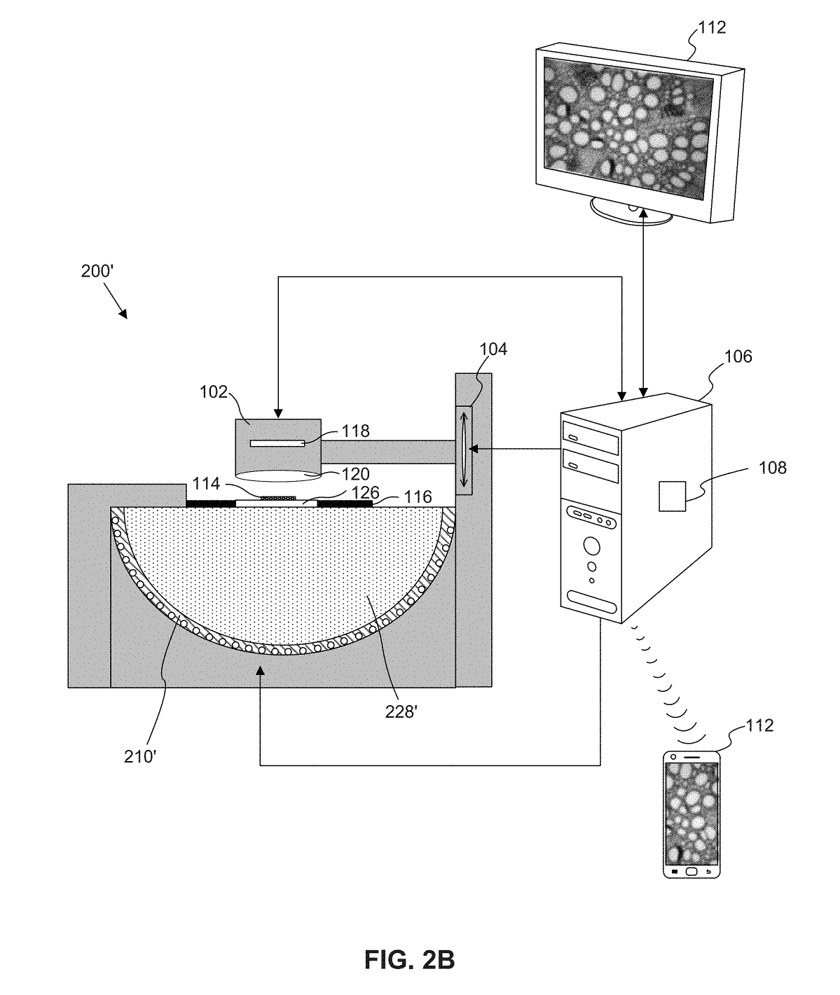

In some embodiments, illumination assembly 110 may include at least one illumination source located in a plane or along a curve. In one embodiment, as shown in FIG. 1, illumination assembly 110 includes a portion 110a positioned substantially parallel to a plane including a surface of slide 126 on or in which sample 114 is included. Illumination assembly 110 may also include side portions 110b oriented substantially perpendicular to (i.e., about 90 degrees with respect to) a plane including a surface of slide 126. Other orientations, however, are also possible. For example, in the embodiment shown in FIG. 2A, the illumination assembly 210 includes side portions oriented at an angle not orthogonal to slide 126. For example, in some embodiments one or more of the side portions of illumination assembly 210 may be oriented such that an angle θ, as shown in FIG. 2A, relative to a plane parallel to a surface of slide 126 is greater than 30 degrees. In some embodiments, θ may be between about 30 degrees and 90 degrees. In other embodiments, θ may be between about 40 degrees and 70 degrees. In still other embodiments, θ may be within a range of about 55 degrees to about 65 degrees.

Returning to the embodiment illustrated in FIG. 1, illumination assembly 110 includes a first illumination source 110a located in a first plane perpendicular to an optical axis of image sensor 118, and a second illumination source 110b located in a second plane parallel to the optical axis of image sensor 118.

Illumination assembly 110 may be configured to illuminate sample 114 under two or more different illumination conditions. In one example, illumination assembly 110 may include a plurality of light sources arranged in different illumination angles, such as a two-dimensional arrangement of light sources. In this case, the different illumination conditions may include different illumination angles. For examples, FIG. 1 depicts a beam 122 projected from a first illumination angle α₁, and a beam 124 projected from a second illumination angle α₂. In some embodiments, first illumination angle α₁ and second illumination angle α₂ may have the same value but opposite sign. In another example, illumination assembly 110 may include a plurality of light sources configured to emit light in different wavelengths. In this case, the different illumination conditions may include different wavelengths. In yet another example, illumination assembly 110 may configured to use a number of light sources. In this case, the different illumination conditions may include different illumination patterns. Accordingly and consistent with the present disclosure, the different illumination conditions may be selected from a group including: different durations, different intensities, different positions, different illumination angles, different illumination patterns, different wavelengths, or any combination thereof. Accordingly, image capture device 102 captures image information of sample 114 at each of the two or more different illumination conditions. In addition, the processing devices in controller 106 are programmed to generate a high resolution image of sample 114 based on a combination of images captured at each of the two or more different illumination conditions. The high resolution image may have a resolution higher than any individual one of the images captured at each of the two or more different illumination conditions. In some embodiments, the high resolution image may be generated in an iterative or a non-iterative process.

Consistent with disclosed embodiments, microscope 100 may be connected with, or in communication with (e.g., over a network or wirelessly, e.g., via Bluetooth), user interface 112. The term “user interface” refers to any device suitable for presenting a magnified image of sample 114 or any device suitable for receiving inputs from one or more users of microscope 100. FIG. 1 illustrates two examples of user interface 112. The first example is a smartphone or a tablet wirelessly communicating with controller 106 over a Bluetooth, cellular connection, or a WiFi connection, directly or through a remote server. The second example is a PC display physically connected to controller 106. In some embodiments, user interface 112 may include user output devices, including, for example, a display, tactile device, speaker, etc. In other embodiments, user interface 112 may include user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

In some embodiments, microscope 100 may also include or be connected to stage 116. Stage 116 includes any horizontal rigid surface where sample 114 may be mounted for examination. In the embodiment of FIG. 1, stage 116 includes mechanical connector for supporting a slide 126 on which sample 114 is mounted or embedded. The mechanical connector may use one or more of the following: a mount, an attaching member, a holding arm, a clamp, a clip, an adjustable frame, a locking mechanism, a spring, or any combination thereof. Slide 126 may include any optical transparent material such as, for example, glass. In some embodiments, stage 116 may include a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

Microscope 100 may further include at least one refractive index matching material 128 positioned between sample 114 (or slide 126 on which sample 114 is mounted or embedded) and illumination assembly 110. In some of the disclosed embodiments, refractive index matching material 128 is a material different from a medium present between objective lens 120 of image capture device 102 and sample 114. In some embodiments, the “medium” present between objective lens 120 of image capture device 102 and sample 114 may include air. In other embodiments, the medium may constitute a material other than air. For example, in some embodiments, the medium may include oil or water. As use herein, the medium refers to one or more materials or compounds etc. present between the sample and light gathering components of microscope 100 (e.g., object lens 120, image capture device 102, or any components or subassemblies thereof). The medium does not include structural elements of microscope 100.

Refractive index matching material 128 may have a refractive index that is greater than 1.1. In some embodiments, the refractive index of refractive index matching material 128 may be close or similar to the refractive index of slide 126 on which sample 114 is mounted or embedded. For example, slide 126 may be glass.

In some embodiments, the refractive index of refractive index matching material 128 is within ±15% of a refractive index of slide 126 (e.g., glass) on which the sample is mounted or embedded. Alternatively, in some embodiments the refractive index of refractive index matching material 128 is within ±20% of a refractive index of slide 126 on which the sample is mounted or embedded. In some cases, refractive index matching material 128 may include water or oil.

Refractive index matching material 128 may also include one or more non-liquid materials. For example, refractive index matching material 128 may include glass, a polymer, or a gel (e.g., a gel constituting a non-liquid and non-solid, but semirigid material). In addition to these materials or combinations of these materials, refractive index matching material 128 may include one or more of the following refractive index matching materials: aero and textured polymers, polytetrafluoroethylene (PTFE), perfluoroalkoxy (PFA), magnesium fluoride (MgF2), polyvinylidene fluoride (PVDF), calcium fluoride (CaF2), fused silica, cellulose acetate butyrate (CAB), acrylate (PMMA), borosilicate (BK), polyvinyl alcohol (PVOH PVA), cyclic olefin (COC or COP), silicon dioxide (SiO₂), barium silicate (BaK), benzocyclobutene (BCB), polycarbonate (PC), polysulfone, polyester (PET), and polyimide. Refractive index matching material 128 may also include one or more of the following refractive index matching materials: oil, cultured cells, type F oil, glycerol, silicon oil, water, phosphate-buffered saline (PBS), MOWIOL®, VECTASHIELD®, Canada balm. Refractive index matching material 128 may further include one or more of the following materials: polydimethylsiloxane (PDMS), PARALOID® B-72, and epoxy.

In some embodiments, refractive index matching material 128 may include a single, substantially homogenous material (e.g., any of the materials listed above). In other embodiments, refractive index matching material 128 may constitute a composite of one or more of the listed materials. For example, refractive index matching material 128 may include a layered structure, where adjacent layers include different materials (optionally with different indices of refraction). In such cases, refractive index matching material 128 may be tuned such that rather than providing a single index of refraction, refractive index matching material 128 may include multiple indices of refraction across respective layers or regions. In some embodiments, refractive index matching material 128 may include a primary component (e.g., glass or other material) and a secondary component (e.g., oil, gel, etc.) that acts as a buffer between the primary component and either illumination assembly 110 or between the primary component and sample 114 or slide 126.

As noted, in some embodiments, refractive index matching material 128 may include one or more materials different from a medium present between sample 126 and light gathering components of microscope 10. In these embodiments, any one or more of the materials listed above may be used to make refractive index matching material 128, as long as those one or more materials are different from the medium present between the sample and light gathering components of the microscope. For example, in some embodiments, refractive index matching material 128 may include glass, and the medium between image capture device 102 and sample 114 may include air or oil. Alternatively, in some embodiments, refractive index matching material 128 may include a gel, and the medium between image capture device 102 and sample 114 may include air or oil.

Refractive index matching material 128 may function to reduce refraction of incident light from illumination assembly 110 to sample 114. As a result, refractive index matching material 128 may help preserve an intended illumination angle of incident light by reducing or eliminating refraction of the incident light that would effectively increase the angle of incidence of the light emitted from illumination assembly 110. Especially in the case of a computational microscope, which relies upon multiple images collected under different illumination conditions (e.g., lower and lower angles of incidence), this limitation in the range of incidence angles available can significantly limit the potential resolution of the image generated by microscope 100.

In some embodiments as shown in FIG. 1, refractive index matching material 128 may be configured to contact sample 114 or slide 126, such that there is substantially no air gap between at least a portion of refractive index matching material 128 and at least a portion of sample 114 or slide 126. In some cases, slide 126 or sample 114 may directly contact refractive index matching material 128 without intervening materials. In other cases, one or more intervening structures may be present between refractive index matching material 128 and slide 126 or sample 114. For example, stage 116 may be configured to support slide 126 from the ends of slide 126 such that refractive index matching material 128 may directly contact slide 126. In other embodiments, stage may include one or more light-transmissive portions that contact slide 126 on one side and refractive index matching material 128 on an opposite side. An important aspect is that it may not be sufficient in many cases to simply place, for example, the glass slide with the sample on top of another solid material (glass or other) which is likely to contain air gaps and limit the illumination angle. Under these circumstances, index matching may be provided in a way that refraction between two solid materials is minimized.

In the embodiment illustrated in FIG. 1, refractive index matching material 128 is in contact with a lower surface of slide 126 on which sample 114 is located. Refractive index matching material 128 may be formed in any suitable shape. For example, in some embodiments, refractive index matching material 128 may be formed with a cubical, cuboid, or rectangular prism shape. In other embodiments, refractive index matching material 128 may include a hemispheric shape, a cylindrical shape, etc. The refractive index matching material 128 may be transparent or translucent. In the embodiment illustrated in FIG. 1, refractive index matching material 128 is formed of a solid rectangular cube, or other suitable shape (e.g., an irregular shape).

Refractive index matching material 128 may be formed with suitable dimensions to fit the shape of at least a portion of illumination assembly 110. In some embodiments, refractive index matching material 128 may be formed of any size to occupy at least 75% of an optical path from at least a portion of illumination assembly 110 to sample 114. That is, at least 75% of an optical path from at least a portion of illumination assembly 110 to sample 114 includes refractive index matching material 128.

Further, in some embodiments, refractive index matching material 128 may contact at least a portion of illumination assembly 110 with no air gap formed between refractive index matching material 128 and the portion of illumination assembly 110. In the embodiment illustrated in FIG. 1, refractive index matching material 128 contacts both first illumination source 110a and second illumination source 110b of illumination assembly 110. For example, first illumination source 110a and second illumination source 110b may be mounted on refractive index matching material 128.

In an alternative embodiment, refractive index matching material 128 may be spaced apart from illumination assembly 110 with an air gap formed between refractive index matching material 128 and illumination assembly 110. In one example, the air gap may be less than or equal to 1 cm. In another example, the air gap may be less than or equal to 0.5 cm. In some embodiments with such a gap, oil or a gel may be placed in the gap.

FIG. 2B is a diagrammatic representation of a microscope 200′ including a refractive index matching material 228′ formed as a solid hemisphere, consistent with another exemplary embodiment. Microscope 200′ is substantially the same as microscope 100 illustrated in FIG. 1, except that microscope 200′ includes an illumination assembly 210′ instead of illumination assembly 110, and refractive index matching material 228′ instead of refractive index matching material 128. As illustrated in FIG. 2B, refractive index matching material 228′ is formed of a solid transparent hemisphere. Illumination assembly 210′ includes an illumination source located along a spherical portion of refractive index matching material 228′. A top and flat portion of refractive index matching material 228′ is in contact with a portion of the lower surface of slide 126 on which sample 114 is located. In some cases, this contact may eliminate air gaps, in a way that creates or enhances optical matching. A bottom surface of refractive index matching material 228′ contacts illumination assembly 210′ (e.g., with no air gap formed between refractive index matching material 228′ and illumination assembly 210′). For example, illumination assembly 210′ may be mounted on refractive index matching material 228. For example, in this figure the illumination assembly includes parts which are curved with an angle more than 30 degrees from the axis parallel to the sample plane. Note that in this embodiment, the hemisphere can, but does not have to, be configured to operate as a lens.

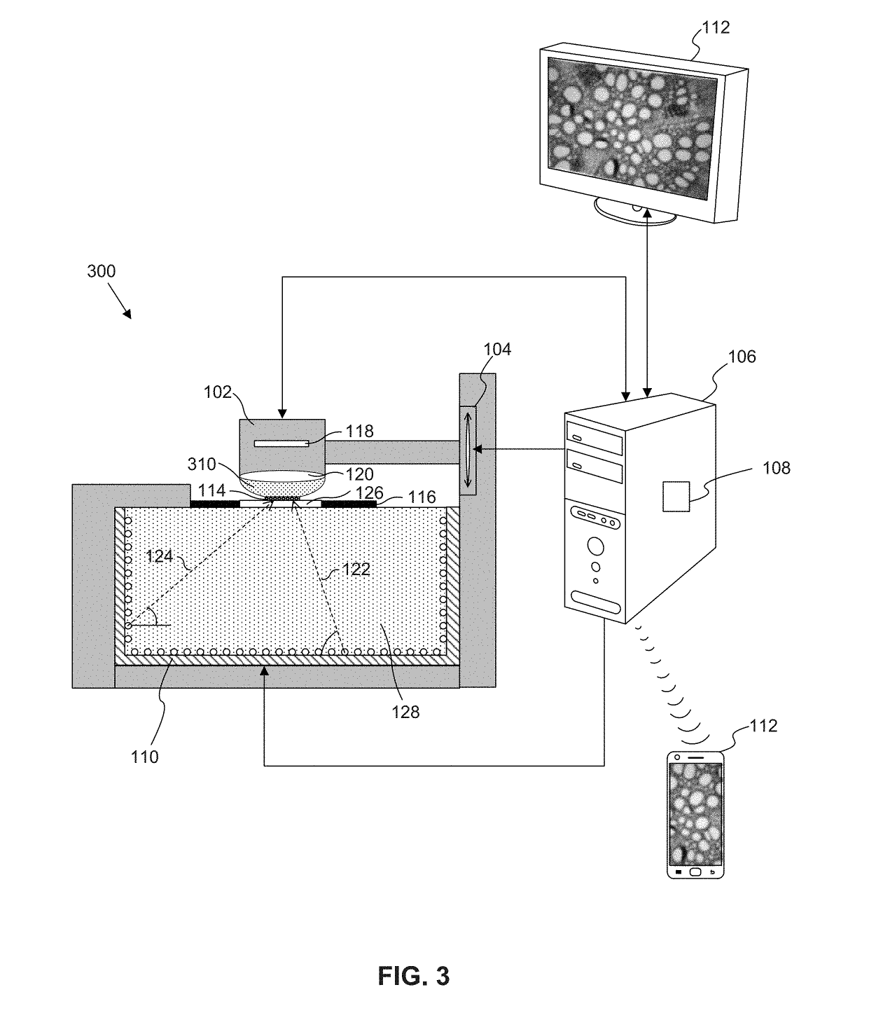

FIG. 3 is a diagrammatic representation of a microscope 300 including refractive index matching material 128 (first refractive index matching material) between sample 114 and illumination assembly 110, and a second refractive index matching material 310 between sample 114 and image capture device 102, consistent with an exemplary embodiment. Microscope 300 is substantially the same as microscope 100 illustrated in FIG. 1, except that microscope 300 additionally includes second refractive index matching material 310 in addition to first refractive index matching material 128

As illustrated in FIG. 3, second refractive index matching material 310 is located between sample 114 and objective lens 120 of image capture device 102. Second refractive index matching material 310 contacts an upper surface of sample 114 with no air gap formed between second refractive index matching material 310 and sample 114. In addition, second refractive index matching material 310 contacts a lower surface of objective lens 120 with no air gap formed between refractive index matching material 310 and objective lens 120.

Second refractive index matching material 310 may have a refractive index of greater than 1.1. Second refractive index matching material 310 may include any refractive index matching material selected from the list of materials described for first refractive index matching material 128. Second refractive index matching material 310 may include the same material as first refractive index matching material 128. Alternatively, second refractive index matching material 310 may include a material different from that of first refractive index matching material 128. In some embodiments, first refractive index matching material 128 may include a non-liquid refractive index matching material and second refractive index matching material 310 may include a non-liquid refractive index matching material different from that of first refractive index matching material 128. For example, first refractive index matching material 128 may include a first gel and second refractive index matching material 310 may include a second gel. The first gel of first refractive index matching material 128 and the second gel of second refractive index matching material 310 may be substantially the same material. Alternatively, the first gel of first refractive index matching material 128 and the second gel of second refractive index matching material 310 may be different materials. In cases, where the first refractive index matching material 128 and the second refractive index matching material 310 constitute gels of the same material, microscope 300 may be configured such that the region between the illumination assembly and the light gathering optics of the microscope is fully immersed with the gel material.

In some embodiments, first refractive index matching material 128 between sample 114 and illumination assembly 110 may include more than one portion. For example, refractive index matching material 128 may include two portions, or three portions, or more than three portions.

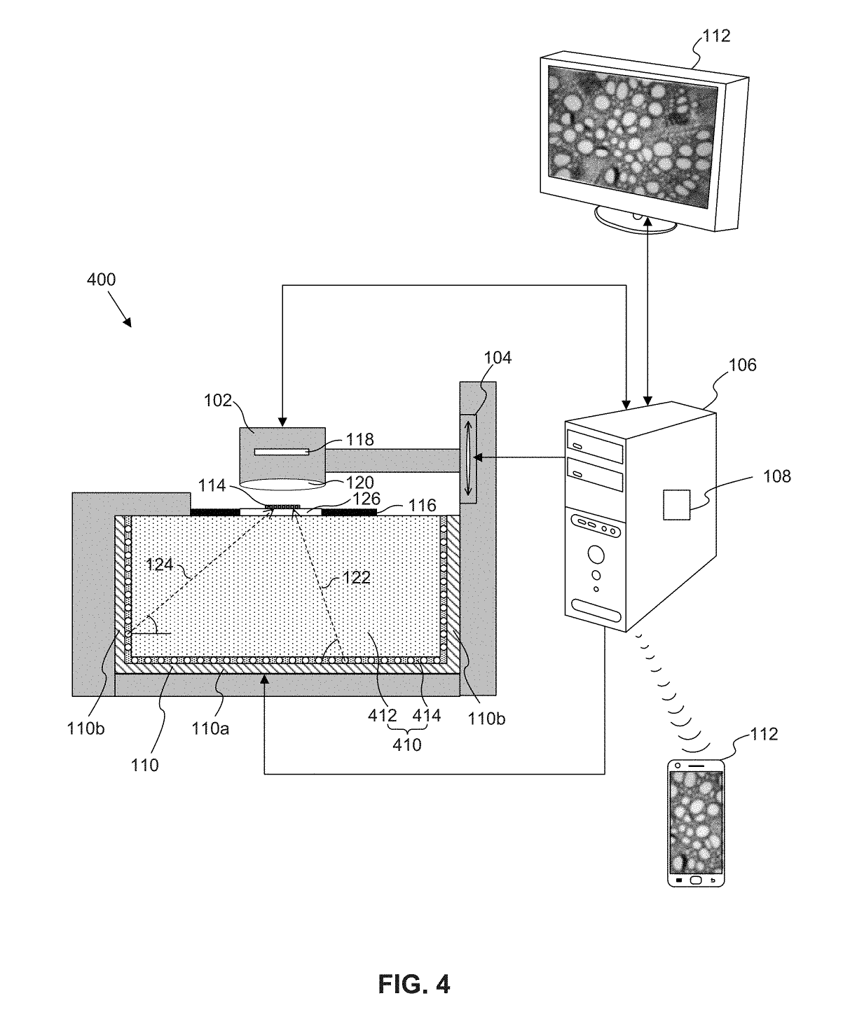

FIG. 4 is a diagrammatic representation of a microscope 400 including a refractive index matching material 410 having first and second portions 412 and 414, consistent with an exemplary embodiment. Microscope 400 is substantially the same as microscope 100 illustrated in FIG. 1, except that microscope 400 includes refractive index matching material 410 instead of refractive index matching material 128.

As illustrated in FIG. 4, refractive index matching material 410 includes first portion 412 and second portion 414. First portion 412 contacts the lower surface of slide 126 on which sample 114 is mounted or embedded with no air gap formed between first portion 412 and slide 126. Second portion 414 is located between first portion 412 and illumination assembly 110 and contacts illumination assembly 110 with no air gap formed between second portion 414 and illumination assembly 110. First portion 412 and second portion 414 may be made of same or different refractive index matching materials. In some embodiments, first portion 412 may include glass and second portion 414 may include a gel. In some alternative embodiments, first portion 412 may include glass and second portion 414 may include oil. In the embodiment illustrated in FIG. 4, first portion 412 is larger than second portion 414.

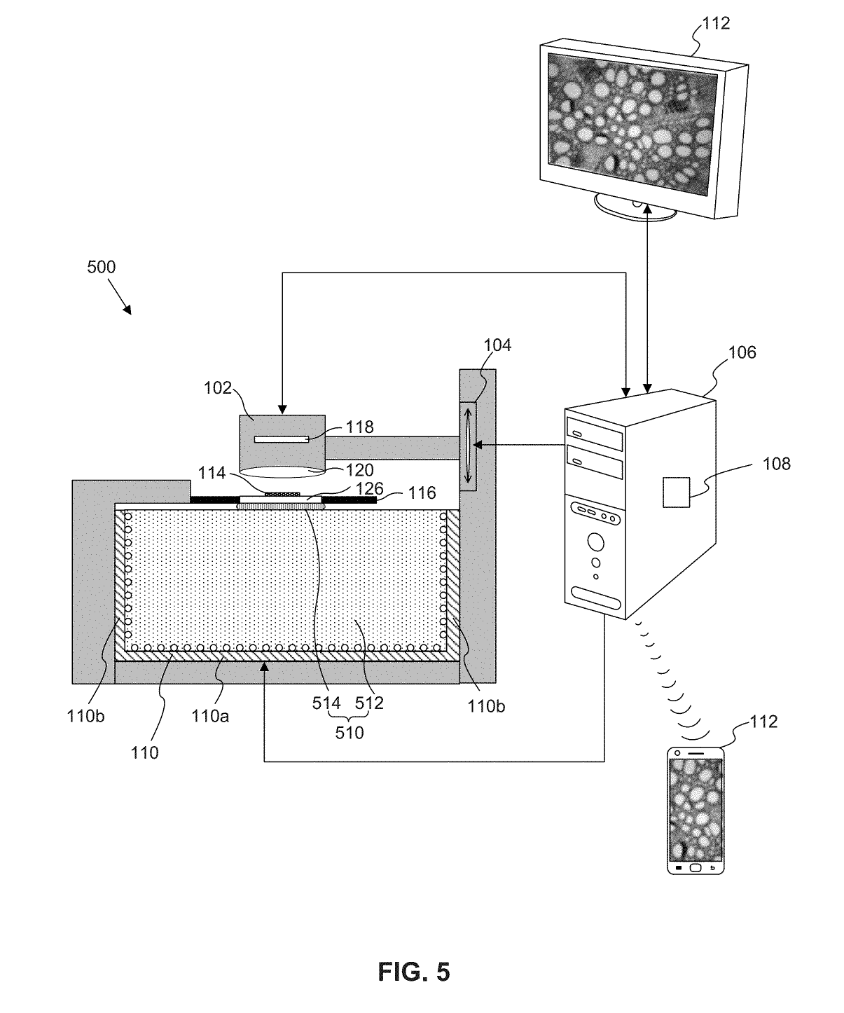

FIG. 5 is a diagrammatic representation of a microscope 500 including a refractive index matching material 510 having first and second portions 512 and 514, consistent with another exemplary embodiment. Microscope 500 is substantially the same as microscope 100 illustrated in FIG. 1, except that microscope 500 includes refractive index matching material 510 instead of refractive index matching material 128.

As illustrated in FIG. 5, refractive index matching material 510 includes first portion 512 and second portion 514. First portion 512 contacts illumination assembly 110 with or without air gap formed between first portion 512 and illumination assembly 110. Second portion 514 is located between first portion 512 and slide 126 on which sample 114 is mounted or embedded, and contacts the lower surface of slide 126 with no air gap formed between slide 126 and second portion 514. First portion 512 and second portion 514 may be made of different refractive index matching materials. For example, first portion 512 may be made of glass and second portion 514 may be made of gel or oil. In the embodiment illustrated in FIG. 5, first portion 512 is larger than second portion 514.

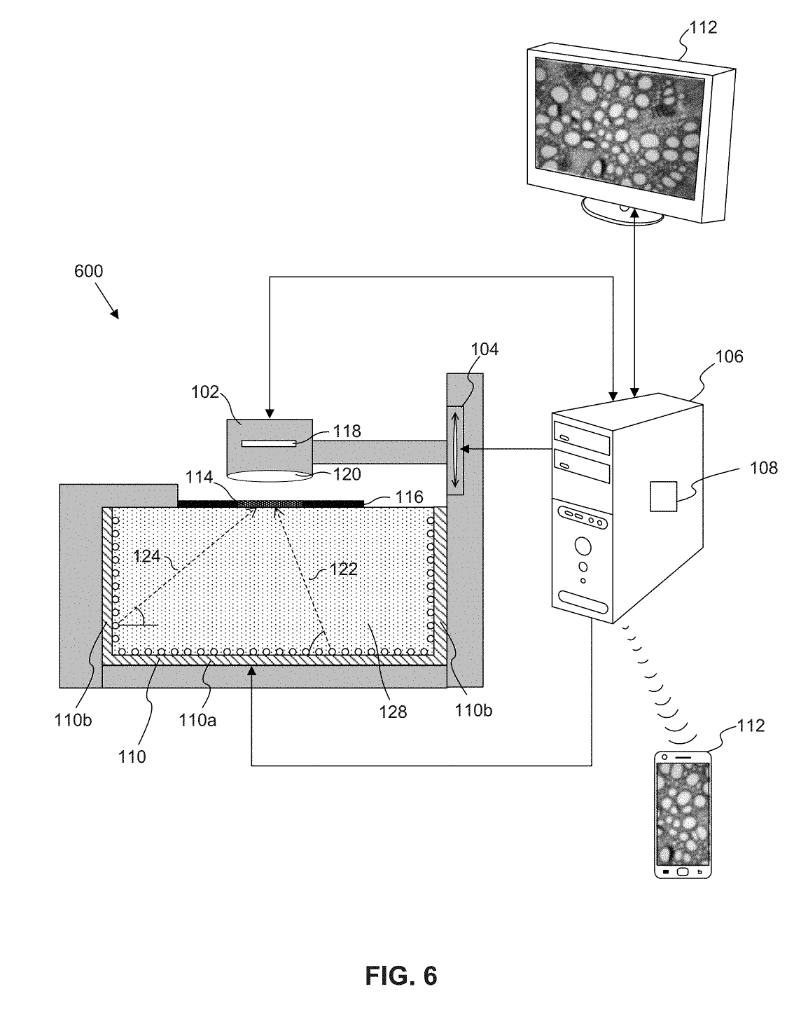

FIG. 6 is a diagrammatic representation of a microscope 600 including refractive index matching material 128 that contacts sample 114, consistent with an exemplary embodiment. Microscope 600 is substantially the same as microscope 100 illustrated in FIG. 1, except that stage 116 of microscope 600 does not include a slide. Instead, sample 114 is directly supported by stage 116. In this case, refractive index matching material 128 may directly contact sample 114 with no air gap formed between refractive index matching material 128 and sample 114.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A microscope, comprising:
an illumination assembly configured to illuminate a sample under two or more different illumination conditions;
at least one image capture device configured to capture image information associated with the sample at each of the two or more different illumination conditions;
at least one processing device programmed to generate an image of the sample based on a combination of image information captured at each of the two or more different illumination conditions; and
at least one refractive index matching material between the illumination assembly and the sample, wherein the refractive index matching material is different from a medium between the at least one image capture device and the sample.

2. The microscope of claim 1, wherein at least 75% of an optical path from at least a portion of the illumination assembly to the sample includes the refractive index matching material.

3. The microscope of claim 1, wherein the medium includes air.

4. The microscope of claim 1, wherein the medium includes oil.

5. The microscope of claim 1, wherein the refractive index matching material is non-liquid.

6. The microscope of claim 1, wherein the refractive index matching material includes glass, a polymer, or a gel.

7. The microscope of claim 1, wherein the refractive index matching material includes glass, and the medium includes air or oil.

8. The microscope of claim 1, wherein the refractive index matching material includes oil or a gel, and the medium includes air.

9. The microscope of claim 1, wherein the refractive index matching material comprises a first portion and a second portion, and the first portion and the second portion are made of different materials.

10. The microscope of claim 9, wherein the second portion of the refractive index matching material is disposed between the first portion of the refractive index matching material and the sample.

11. The microscope of claim 9, wherein the first portion includes glass and the second portion includes a gel.

12. The microscope of claim 9, wherein the first portion includes glass and the second portion includes oil.

13. The microscope of claim 1, wherein the refractive index matching material has a refractive index greater than 1.1.

14. The microscope of claim 1, wherein the refractive index matching material has a refractive index within ±15% of a refractive index of glass on which the sample is mounted or embedded.

15. The microscope of claim 1, wherein the refractive index matching material has a refractive index within ±20% of a refractive index of glass on which the sample is mounted or embedded.

16. The microscope of claim 1, wherein the refractive index matching material includes a solid cube or a solid hemisphere.

17. The microscope of claim 1, wherein the at least one image capture device includes an objective lens configured to collect light transmitted through the sample, and the at least one image capture device is located in a region on an opposite side of the sample relative to the illumination assembly.

18. The microscope of claim 1, wherein the illumination assembly includes at least one LED, an LED array, a laser, a halogen lamp, or a mercury lamp.

19. A microscope, comprising:
an illumination assembly configured to illuminate a sample under two or more different illumination conditions;
at least one image capture device configured to capture image information associated with the sample at each of the two or more different illumination conditions;
at least one processing device programmed to generate a high resolution image of the sample based on a combination of image information captured at each of the two or more different illumination conditions, wherein the high resolution image of the sample has a resolution higher than any individual one of the plurality of images; and
at least one refractive index matching material between the illumination assembly and the sample, wherein the refractive index matching material is different from a medium between the at least one image capture device and the sample.

20. The microscope of claim 19, wherein at least 75% of an optical path from at least a portion of the illumination assembly to the sample includes the first refractive index matching material.

21. The microscope of claim 19, wherein the refractive index matching material includes glass, a polymer, or a gel, and the medium includes air or oil.

22. A microscope, comprising:
an illumination assembly configured to illuminate a sample under two or more different illumination conditions;
at least one image capture device configured to capture image information associated with the sample at each of the two or more different illumination conditions;
at least one processing device programmed to generate an image of the sample based on a combination of image information captured at each of the two or more different illumination conditions;
a first refractive index matching material between the illumination assembly and the sample, wherein the first refractive index matching material includes a first gel; and
a second refractive index matching material between the at least one image capture device and the sample, wherein the second refractive index matching material includes a second gel.

23. The microscope of claim 22, wherein the first gel and the second gel are substantially the same material.

24. The microscope of claim 22, wherein the first gel and the second gel are different materials.
